(19) United States
(12) Patent Application Publication
(10) Pub. No.: US 2015/0235477 A1
(43) Pub. Date: Aug. 20, 2015

(54) Automatic Wireless Transportation Monitoring and Transactions for Mobile Devices

(71) Applicant: Swyft Technologies Inc., San Francisco, CA (US)

(72) Inventors: Jonathan Simkin, San Francisco, CA (US); William Morgan Dayton, San Francisco, CA (US)

(21) Appl. No.: 14/626,057

(22) Filed: Feb. 19, 2015

Related U.S. Application Data
(60) Provisional application No. 61/941,971, filed on Feb. 19, 2014.

(51) Int. Cl. G07B 13/08

(52) U.S. Cl. CPC G07B 13/08

(57) ABSTRACT

A method for automated fare processes includes a mobile device detecting transmissions from a beacon located on a vehicle. Based on the detected transmissions, the mobile device determines that it has entered the vehicle. Entry data including an entry time is stored by the mobile device. When the mobile device exits the vehicle, an exit data including an exit time is stored by the mobile device. A beacon identifier is also included in the entry data, the exit data, or both. Computation of a fare is initiated, where the fare is based on the entry data and the exit data.

### CROSS REFERENCE TO RELATED APPLICATION

This application claims priority to U.S. Patent Application Ser. No. 61/941,971 filed on Feb. 19, 2014, entitled “Automatic Wireless Transactions for Mobile Devices”, the contents of which are incorporated by reference herewith in its entirety.

### TECHNICAL FIELD

The subject matter described herein relates to facilitating automatic wireless transportation monitoring and transactions with mobile devices.

### BACKGROUND

There have been solutions that enable mobile devices to facilitate various forms of transaction—such as mobile payments, ticket processing for events, loyalty rewards processing, unlocking a door, etc.; however, existing solutions necessitate direct user interaction (e.g., pressing a button, tapping an NFC register, or exposing a QR Code) and are not widely adopted. The inconvenience of these additional steps results in little to no significant benefit over traditional forms of transaction such as paying with paper money or a credit card, using a paper ticket, keys, etc.

### SUMMARY

This disclosure includes implementations of systems, apparatus, methods, and computer program products related to facilitating automatic wireless transactions using mobile devices. Additionally, at least some implementations include features for authenticating and validating the automatic wireless transactions. Several applications of the system and methods have been contemplated, some of which are described herein, including, for example, applications that facilitate automatic payments for public transportation and the determination of passenger flow and/or transit data.

In one aspect, a mobile device detects transmissions from a beacon located on a vehicle as part of an automated fare process. Based on the detected transmissions, the mobile device determines that it has entered the vehicle. Entry data including an entry time is stored by the mobile device. When the mobile device exits the vehicle, an exit data including an exit time is stored by the mobile device. A beacon identifier is also included in the entry data, the exit data, or both. Computation of a fare is initiated, where the fare is based on the entry data and the exit data.

In one variation, the computation of the fare and data associated with the fare can be performed on the mobile device.

In another variation, the mobile device can transmit the associated entry data and exit data to a remote computing system. The remote computing system can compute the fare, detect the computed fare from a payment account associated with the user of the mobile device, and transmit data encapsulating the fare to the mobile device. Also, the mobile device can receive, from the remote computing system, transit data representative of a transit environment. This transit data can include information such as occupancy data and scheduling data.

In yet another variation, the mobile device can receive a beacon identifier and store the beacon identifier along with a time stamp corresponding to the time when the beacon identifier was received by the mobile device. Also, the entry data and can include a time at which the beacon transmission was first detected and the exit data can include a time at which the beacon transmission was last detected.

In a further variation, the entry data and the exit data can be determined based on the calculated distance from the beacon to the mobile device. The calculated distance can be based on signal strength of the beacon transmissions received from the mobile device. Also, the entry data and the exit data can include geolocation data of the mobile device, the beacon identifier, a vehicle identifier, and a user identifier.

In one variation, the entry data includes an entry location corresponding to the location of the user at the entry time and the exit data includes an exit location corresponding to the location of the user at the exit time. Initiating of fare can include calculating the fare based on the entry time, the entry location, the exit time, and the exit location, and according to a fare schedule stored on the mobile device.

In another variation, the mobile device can determine that it is within a barrier proximity that defines a pre-defined distance from a barrier. When the mobile device is in the barrier proximity, the mobile device can transmit a request to a server for the barrier to actuate. The server can transmit a command to an actuator controlling the barrier for the barrier to actuate.

In one variation, when the mobile device is within a vehicle outer proximity, an outer proximity status can be transmitted by the mobile device to the server. The outer proximity status can identify the mobile device and the vehicle. The mobile device can display information about the corresponding vehicle.

In a further variation, communication between the mobile device and the beacon can be synchronous or asynchronous.

In an interrelated aspect, a mobile device detects transmissions from a beacon located on a vehicle as part of an automated fare process. Based on the detected transmissions, the mobile device determines that it has entered the vehicle. Also, entry data including an entry time is stored by the mobile device. When the mobile device exits the vehicle, an exit data including an exit time is stored by the mobile device. A beacon identifier is also included in the entry data, the exit data, or both. Computation of transit data is initiated, where the transit data is based on a route specified by the entry data and the exit data.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter provides many technical advantages. For example, the current subject matter enables for various types of transactions to be executed using little or no active input from a user.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

These and other aspects will now be described in detail with reference to the following drawings.

FIG. 1 is a diagram illustrating a wireless mobile transaction system including a beacon, a mobile device, and a remote computing system;

FIG. 2 is a diagram illustrating the mobile device passing through varying proximities to the beacon as a mobile device enters a vehicle;

FIG. 3 is a signal diagram illustrating communication between the beacon, the mobile device, and the remote computing system;

FIG. 4 is a process flow diagram illustrating the wireless mobile transaction system used to determine a fare for a user of the vehicle; and

FIG. 5 is a process flow diagram illustrating the wireless mobile transaction system used to determine transit data for a user of the vehicle.

### DETAILED DESCRIPTION

This document describes a system and method for automatic wireless transportation monitoring and transactions for mobile devices. The system and methods described herein can improve passenger experiences on transportation vehicles as well as data collection and fare systems for transit agencies, all by facilitating automatic transactions with the mobile devices. For example, facilitating automatic passenger monitoring can allow transit agencies to determine linked passenger trips—where a passenger enters and exits a vehicle, with coordinates based on connections between the mobile device and known beacons or on GPS readings from passenger mobile devices. This information can help transportation planners provide better transportation options given where travelers are heading. Additionally, by knowing where the user entered and exited a transit vehicle, this system can allow a user of the mobile device to automatically initiate fare payment for a trip based on distance travelled and other criteria. This can relieve the user from having to perform unwanted additional actions with their mobile device in order to at least initiate the transaction. In some implementations, entire transactions can be completed automatically with the mobile device without the user having to perform any additional actions.

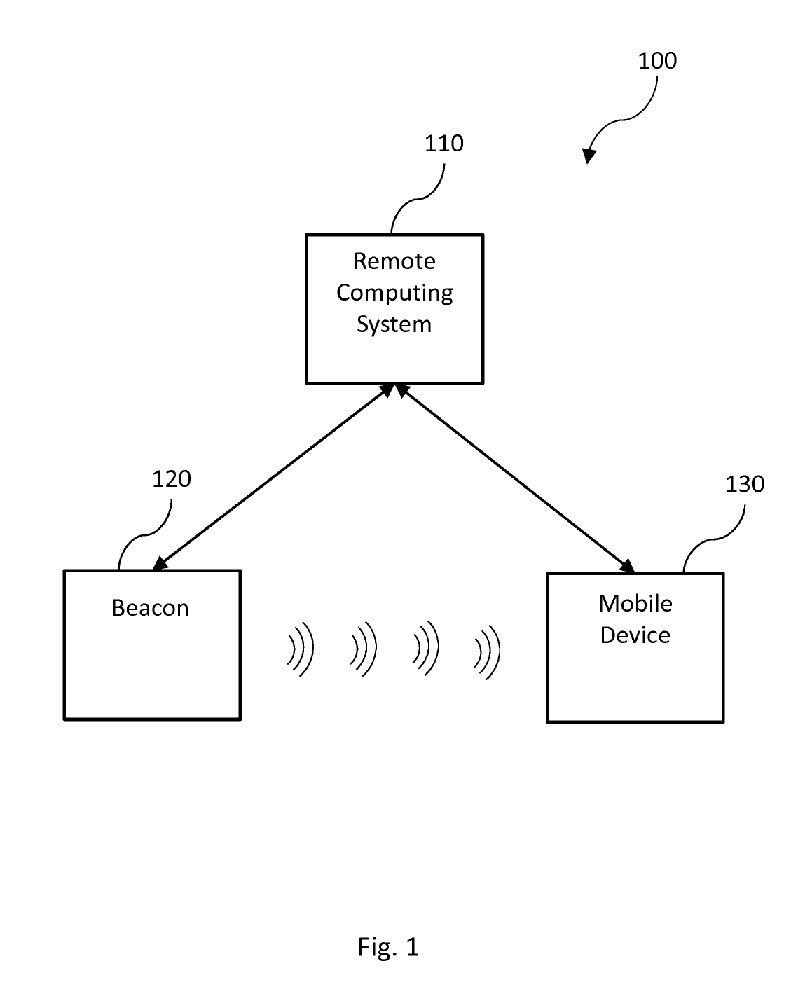

FIG. 1 is a diagram illustrating a wireless mobile transaction system 100 including a remote computing system 110, a beacon 120, and a mobile device 130. The beacon 120 can be configured to transmit a wireless signal, such as through BLUETOOTH, including BLUETOOTH low energy (BLE), or any other of a variety of communication methods. The wireless signal can then be received by the mobile device 130, for example, a mobile phone, tablet, wearable networked devices, etc. which in turn can provide a response to the beacon 120, the remote computing system 110, or both. The beacon 120, mobile device 130, and remote computing system 110 can communicate with each other in order to facilitate and record a variety of information, such as user location information, payment information, travel times, or other information. Additionally, communication with the beacon 120 or other transactions can be completed, or at least initiated, without requiring the user to perform any action on their mobile device 130, such as “pairing”. The remote computing system 110 can include one or more computers that manage the communications between the beacons 120 and mobile devices 130, process consumer transactions such as fares, fees, etc., and provide or receive information to or from the beacon 120 and/or mobile device 130.

The wireless mobile transaction system 100 can have any number of applications that allow data collection and transactions to occur automatically between the beacon 120, including the entity associated with the beacon 120, and the mobile device 130, including the user associated with the mobile device 130. Additionally, any number of beacons 120, remote computing systems 110 and mobile devices 130 can be used in order to complete, or at least initiate, a transaction. In the event that transmission between the mobile device 130 and the remote computing system 110 is not possible, for example, if the mobile device 130 is underground, then data can be stored on the mobile device 130 for later transmission to the remote computing device 110 when communication becomes possible.

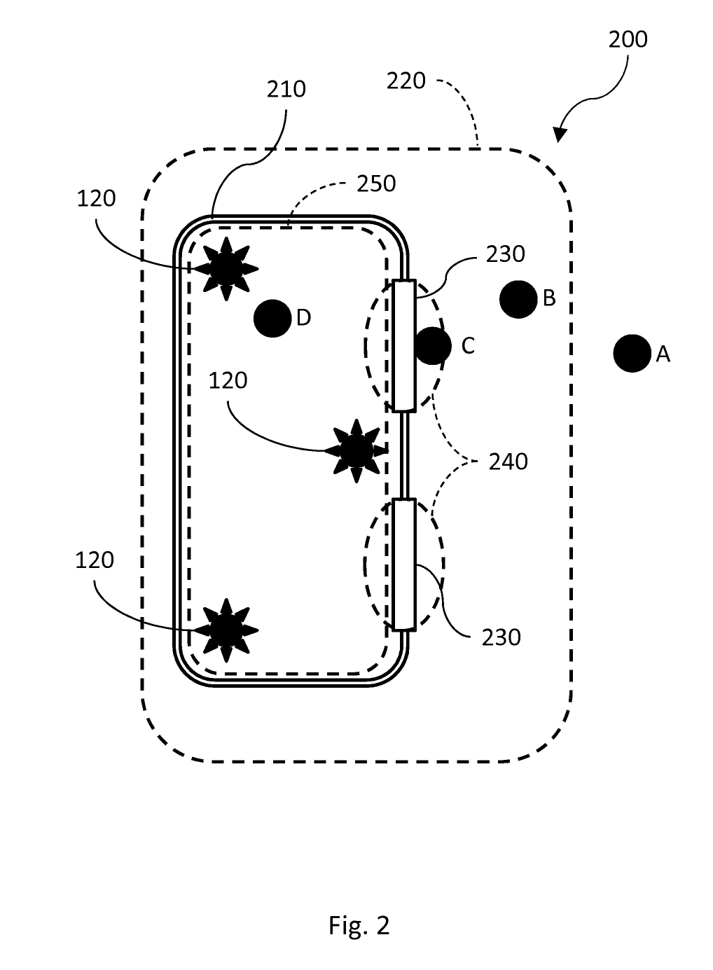

FIG. 2 is a diagram 200 illustrating the mobile device 130 passing through varying proximities to the beacon 120 as the mobile device 130 enters a vehicle 210. The beacon 120 can be used by the mobile device 130 to determine that the mobile device 130 is proximate to the beacon 120. The beacon 120 can be placed in a fixed location, such a room, hallway, doorway, etc. Alternatively, the beacon 120 can be placed in a moving location, for example, a car, taxi, tram, subway car, etc.

The mobile device 130 can determine its relationship to the vehicle 210 by detecting and analyzing transmissions from the beacon 120 located in the vehicle 210. As the mobile device 130 approaches the vehicle 210 it is first out of range of the beacon 120 located inside the vehicle 210. This is illustrated by the mobile device 130 being at position A, which is shown to be outside a vehicle outer proximity 220. The vehicle outer proximity 220 can be the effective range of transmission of the beacon 120. The vehicle outer proximity 220 can vary depending on the intervening structure, for example, people, vehicle walls, type of beacon and transmitting power, etc. Because, at position A, the mobile device 130 is out of range of the beacon 120, transmissions from the beacon 120 cannot be detected by the mobile device 130. However, if the mobile device 130 is able to communicate its location to the remote computing system 110, that information can be used to determine that the mobile device 130 is near the beacon 120 and/or the vehicle 210.

At position B, the mobile device 130 is within the vehicle outer proximity 220 and the mobile device 130 can detect transmissions from the beacon 120. Once the transmissions are detected, which can include the mobile device 130 transmitting a confirmation transmission to the beacon or to the remote computing system 110, the beacon 120 can transmit a beacon identifier and other information to the mobile device 130. In another implementation, the beacon identifier can be transmitted continuously, independent of any detection of the transmissions by the mobile device 130. At this stage, the mobile device 130 can alert the user to information associated with the beacon 120 identifier, for example, information about the vehicle 210, schedules, fares, vehicle occupancy, or etc. The transmissions can be unidirectional, with the mobile device 130 acting only as a receiver for the beacon transmissions, or it can be bi-directional, where synchronizing signals, queries, etc. can be sent between the mobile device 130 and the beacon 120 to establish communication. Communication between the mobile device 130 and the remote computing system 110 can be synchronous or asynchronous. Communication between the mobile device 130 and the beacon 120 can be handled by established software libraries (developed by APPLE, etc.). At this, or any other stage, the transmissions from the beacon 120 to the mobile device 130 can be continuous or intermittent. Similarly, any transmissions from the mobile device 130 to the remote computing system 110 can be continuous or intermittent. Transmissions received by the mobile device 130, from the beacon 120 or the remote computing system 110, can also be time stamped and stored by the mobile device 130, the beacon 120, or by the remote computing system 110.

Distance from the beacon 120 can be calculated by triangulation using multiple beacons, analysis of the signal strength at the mobile device 130 of the transmission from the beacon 120, the geolocation data provided by a GPS running on the mobile device 130, or any combination of the above. The calculation of the distance between one or more beacons 120 and the mobile device 130 can then be used to determine when to acquire entry data and exit data, corresponding to a point in time when the mobile device 130 enters or exits the vehicle 210. In another implementation, the mobile device 130 can transmit the geolocation data to the remote computing device 110 in response to receiving transmissions from the beacon 120 or the cessation of receiving transmissions from the beacon 130. In this way the difference between the geolocation data can be used to determine the distance associated with the entry and exit points.

In another implementation, at position C, it can be determined that the mobile device 130 is near a barrier 230 having a barrier proximity 240. The vehicle 210 can include one or more barriers 230, examples being doors, hatches, sliding panels, etc. The barrier proximity 240 can define an area that extends a pre-defined distance from the barrier 230. When the mobile device 130 is determined to be within the barrier proximity 240, a request for the barrier 230 to actuate can be transmitted by the mobile device 130 to the remote computing system 110. The remote computing system 110 can transmit a command to an actuator controlling operation of the barrier 230 for the actuator to actuate the barrier 230. Other conditions can be required to be satisfied before actuation of the barrier 230, for example, to open the barrier 230 it can be required that that the vehicle 210 is not moving, that the occupancy of the vehicle 210 is below a certain amount, that there are no mobile devices 130 within the barrier proximity 240, etc. Similarly, as the mobile device 130 leaves the barrier proximity 240, a transmission from the mobile device 130 (or lack of transmissions from the mobile device 130) can initiate another request for actuation of the barrier 230, i.e. closing the barrier 230.

At position D, it can be determined that the mobile device 130 has entered the vehicle 210 because it is within a vehicle inner proximity 250. The vehicle 210 inner proximity 250 can be defined by the area inside the vehicle 210, for example, walls, doors, windows, etc. When the mobile device 130 has entered the vehicle 210, the entry data can be stored on the mobile device 130. The entry data can include an entry time, a beacon identifier, a vehicle identifier, a user identifier, or geolocation data from GPS coordinates of the mobile device 130. The entry time, beacon identifier, or the vehicle 210 can be associated with each other to uniquely identify which mobile device entered which vehicle and when the entry occurred. The entry data can be transmitted to the remote computing system 110 or to other devices. Information about the user trip can be reconstructed, for example, routes, schedules, entry and exit points, etc. By locating the mobile device 130 in the vehicle inner proximity 250, additional information such as occupancy, boarding times, seating usage, etc. can be determined.

Though FIG. 2 shows three beacons 120, there can also be additional beacons 120 provided within the vehicle 210, or outside the vehicle 210, to aid with triangulation, enhancing signal strength, etc. There can also be fewer than three beacons 120, if desired. For example, if there were only one beacon 120 located inside the vehicle, the single beacon could be used solely to detect when the mobile device 130 is within range of the beacon 120. When crossing in and out of range of the beacon 120, the mobile device 130 could transmit its GPS coordinates to a remote computing system 110. By tracking the GPS coordinates of the mobile device 130 entering in and out of range of the beacon 120, it is possible to reconstruct the user entry and exit points of the vehicle 210. Also, if the vehicle 210 was moving, or in a state such that one potential location of the mobile device 130 was eliminated, then two beacons 120 would be sufficient to locate the mobile device 130 within the vehicle 210. In addition, the beacons 120 can be cycled on or off to achieve the effect of varying the number of active beacons 120.

For the mobile device 130 exiting the vehicle 210, the above can be reversed, with additional features described below.

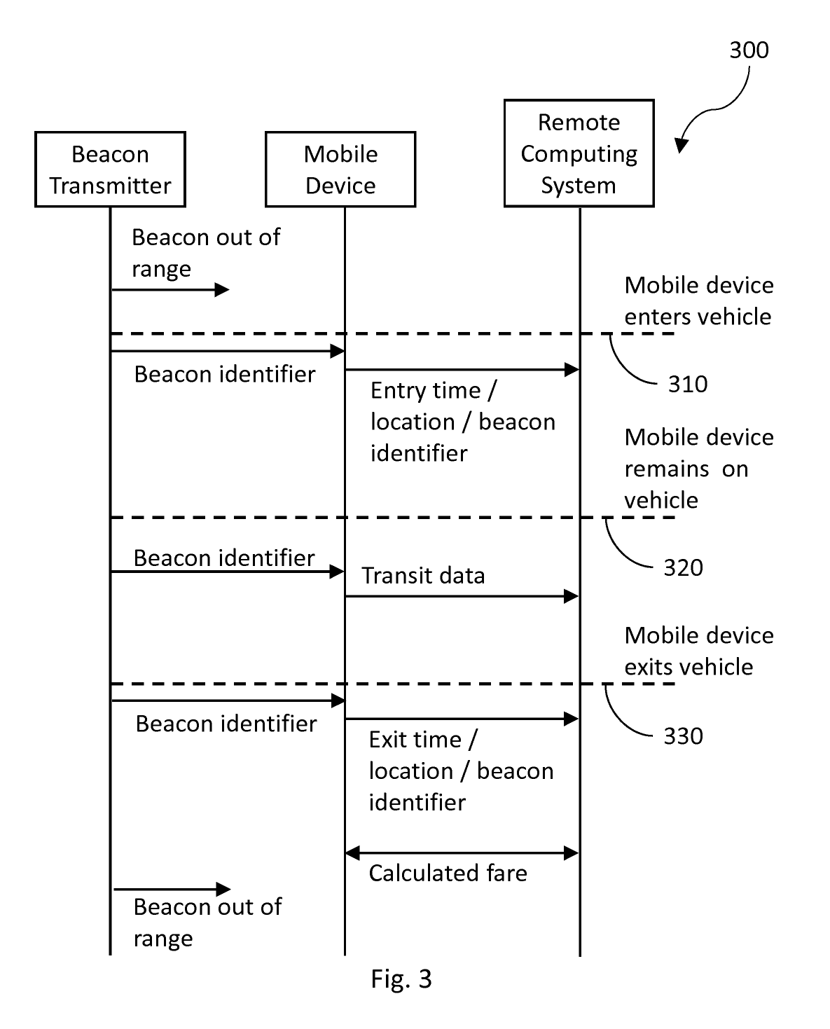

FIG. 3 is a signal diagram 300 illustrating communication between the beacon 120, the mobile device 130, and the remote computing system 110. The signal diagram illustrates a sequence of actions undertaken by the wireless mobile transaction system 100 when the mobile device 130 enters and exits the vehicle 210. The horizontal delineations specify which device is transmitting or receiving a signal. Time advances in the downward vertical direction on the signal diagram, with the mobile device 130 entering the vehicle 210 at the top of the diagram and exiting the vehicle 210 at the bottom of the diagram. Specific events are called out by the dashed lines, and the direction of transmission from device to device is indicated by the arrow direction.

Entry of the mobile device 130 to the vehicle 210 was described in detail in FIG. 2, above. While within the vehicle 210, the mobile device 130 can continue to receive transmissions from and remain connected to and be in communication with, the beacon 120. Transit data about the relation of the mobile device 130 to the vehicle 210 can also continue to be transmitted between the mobile device 130 and the remote computing system 110. Transit data can be representative of a transit environment, including information about the speed and heading of the vehicle 210, as well as numbers, types, and locations of the users of the mobile devices 130 while on the vehicle 210. This can allow the remote computing system 110 to track, among other things, the current location, speed, and heading of the vehicle 210, as well as the number of passengers on the vehicle 210, their movement, their seating choices, or other behavior of interest.

Once the vehicle 210 starts moving, the beacon 120 can continue to transmit. Thus, while in the vehicle 210, the mobile device 130 can continue to receive signals from the beacon 120 from which it can then calculate its distance from the beacon 120 based on the signal strength and/or other inputs, and can provide a response back to the original beacon 120 or to a remote computing system 110, or both. This response can include, but is not limited to, the beacon 120 identifier, location of the mobile device 130, the vehicle 210 identifier, and the user identifier. By knowing the distance between the mobile device 130 and the beacon 120, or the location of the mobile device 130, for example, using GPS, or the time over which the mobile device 130 has received the beacon 120 signal, or any combination thereof, it is possible to determine that the user is still within the vehicle 210.

Also, the mobile device 130 and/or the remote computing system 110 can validate that the user's account has sufficient funds to remain in the vehicle 210. If the user does not have sufficient funds, an alert can be provided to the user via the mobile device 130, a fare inspection manager, or both.

A determination can be made, by the mobile device 130, that the mobile device 130 is no longer in the vehicle 210. The same protocols described in FIG. 2, when going from A to D, apply equally to the mobile device 130 exiting the vehicle 210. However, when exiting the vehicle 210, the mobile device 130 can further store exit data. The exit data can include an exit time corresponding to a point in time at which the mobile device 130 exited the vehicle 210, the beacon identifier, the vehicle identifier, the user identifier, and the geolocation data from GPS coordinates of the mobile device 130. In some cases, the beacon identifier associated with the entry and exit will be the same. In other cases, for example in a vehicle 210 with multiple entry or exit points such as a subway or commuter train, the entry data and the exit data associated with the different entry and exit points can provide valuable information about the usage of the vehicle 210.

As the user leaves the vehicle 210, the mobile device 130 will eventually stop receiving the beacon's signal because the beacon 120 will be out of range. When the mobile device 130 loses the beacon signal, or moves a certain distance away from the beacon 120, the mobile device 130 can communicate with the remote computing system 110. The communication can include the last detected beacon identifier, the vehicle identifier, the user identifier, and the geolocation data from GPS coordinates of the mobile device 130.

All data exchanged and recorded in the wireless mobile transaction system 100, from the time the user enters the vehicle 210 to the time the user leaves the vehicle 210, can be used to help calculate, for example, when and where the user entered the vehicle 210, when and where the user exited the vehicle 210, and how long the user was on the vehicle 210. With this information, it is possible to determine the linked passenger trip, namely the end-to-end passenger journey with origin and destination pairs.

In addition to storing and transmitting of exit data, the mobile device 130 can initiate a computation of a fare, and data associated with the fare, based on the entry data and exit data. Data associated with the fare can include, for example, the entry data, exit data, receipts, trip details, etc. Because a complete record of the user's trip can be stored in the entry data and exit data, the fare can be determined from, among other things, where the user entered and exited the vehicle 210, the time that the user was on the vehicle 210, the route that was taken by the vehicle 210 and/or the user, and other scheduling/fare information that can go into the computation of the fare. Information about the fare, for example, a receipt, a confirmation message, etc. can be displayed by the mobile device 130.

Furthermore, the computing and/or processing of the fare or related transactions, or any of the other operations described herein, can be performed by the mobile device 130 with no additional involvement from the user. For example, an application enabling these features can be downloaded to the mobile device 130. The application, once set up by the user to create an account, etc., can run in the background. The user can then utilize any vehicle 210 outfitted with the beacons 120 and be charged appropriate user fees without further inconvenience. Additionally, alerts of potential fees, insufficient balances, schedule changes, etc. can be provided by the mobile device 130, with such alerts being determined by the interaction of the mobile device 130 with system described herein. For example, in one implementation, the mobile device 130 can be configured to provide a minimum of information to the user. However, if on a particular trip it was determined, prior to boarding, that the user's account contained insufficient funds to pay for the expected trip, the system can suggest alternate routes/times that have lower fares.

Additionally it is possible to automatically charge the user the correct fare without any further actions required by the user. However, the user can verify transactions and/or approve transactions if desired. In addition, if desired, the user can receive current or pending payment alerts via device notifications, emails, texts, or other communication preferences. Furthermore, the mobile device 130 can be used to show proof of payment for a fare inspector. Lastly, if additional authentication is required, the user may authenticate transactions by personal identification number (PIN), signature, or biometric authentication in the vehicle 210, on the fare inspector's device, or through the mobile device 130.

While the storing and transmission of data to the remote computing system 110 was previously described as being performed by the mobile device 130, other devices can also perform the actions with no loss of applicability. For example, the beacons 120 can transmit the entry data and the exit data to the remote computing system 110. This can also include having the remote computing system 110 compute the fare based on the entry data and the exit data. Additionally, the remote computing system, after computing the fare, can transmit data encapsulating the fare to the mobile device 130. Also, different types of data can be transmitted by varying devices, for example, if it is not desired that occupancy data be transmitted to the mobile device 130, then occupancy data can be transmitted only to the remote computing system 110 in order to be invisible to the user of the mobile device 130.

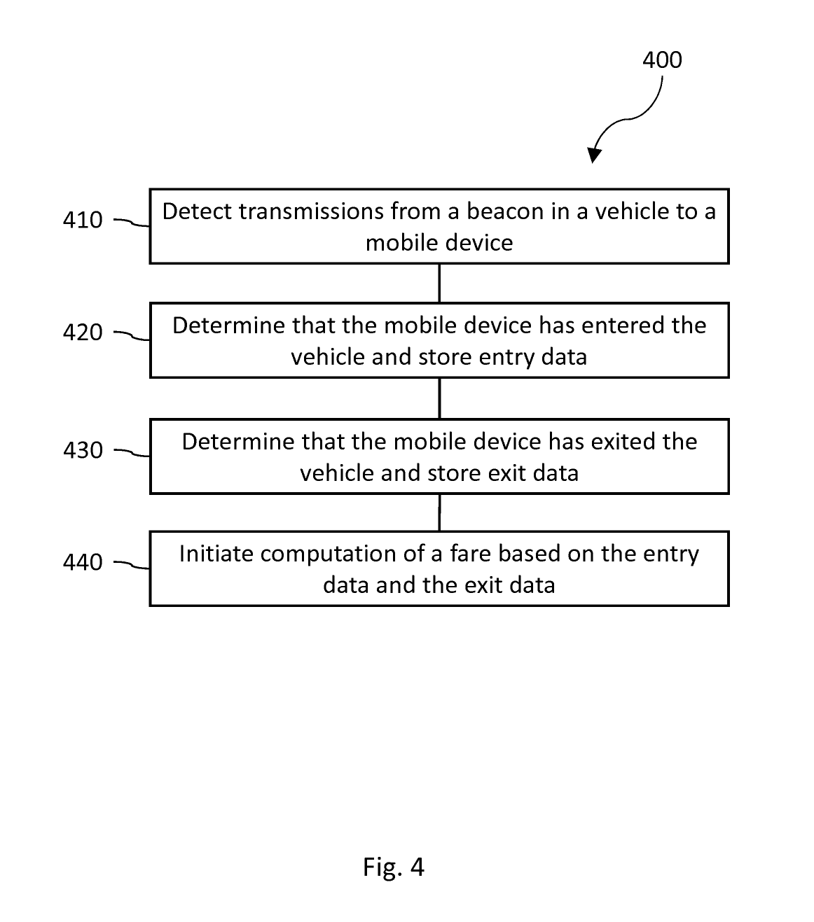

FIG. 4 is a process flow diagram 400 illustrating the wireless mobile transaction system 100 used to determine the fare for the user of the vehicle 210.

At 410, transmissions from the beacon 120 on the vehicle 210 can be detected by the mobile device 130. The detection can further prompt the mobile device 130 and the beacon 120 to initiate bi-directional communication in addition to unidirectional communication.

At 420, a determination can be made, by the mobile device 130 and based on the detected transmissions, that the mobile device 130 has entered the vehicle 210. Entry data associated with determining that the mobile device 130 has entered the vehicle 210 can be stored by the mobile device 130 or sent to the remote computing system 110. The entry data can include the entry time corresponding to a point in time at which the mobile device 130 entered the vehicle 210 and/or the beacon identifier.

At 430, a determination can be made, by the mobile device 130 and based on the transmissions no longer being detected by the mobile device 130, that the mobile device 130 has exited the vehicle 210. Exit data associated with determining that the mobile device 130 has exited the vehicle 210 can be stored by the mobile device 130 or sent to the remote computing system 110. The exit data can include the exit time corresponding to a point in time at which the mobile device 130 entered the vehicle 210 and/or the beacon identifier.

At 440, computation, by the mobile device 130 or by the remote computing system 110, of a fare based at least on the entry data or the exit data can be initiated. The computation can include the entry data and the exit data resulting from the determination of the mobile device 130 entering and/or exiting the vehicle 210.

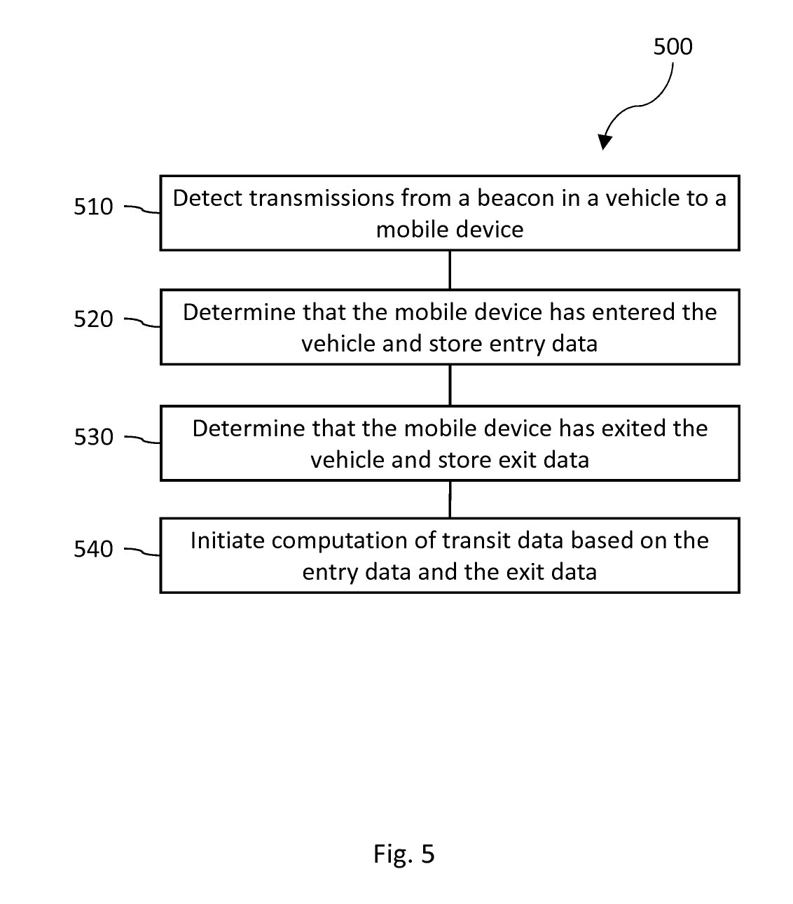

FIG. 5 is a process flow diagram 500 illustrating the wireless mobile transaction system 100 used to determine the fare for the user of the vehicle 210.

At 510, transmissions from the beacon 120 on the vehicle 210 can be detected by the mobile device 130. The detection can further prompt the mobile device 130 and the beacon 120 to initiate bi-directional communication in addition to unidirectional communication.

At 520, a determination can be made, by the mobile device 130 and based on the detected transmissions, that the mobile device 130 has entered the vehicle 210. Entry data associated with determining that the mobile device 130 has entered the vehicle 210 can be stored by the mobile device 130 or sent to the remote computing system 110. The entry data can include the entry time corresponding to a point in time at which the mobile device 130 entered the vehicle 210 and/or the beacon identifier.

At 530, a determination can be made, by the mobile device 130 and based on the transmissions no longer being detected by the mobile device 130, that the mobile device 130 has exited the vehicle 210. Exit data associated with determining that the mobile device 130 has exited the vehicle 210 can be stored by the mobile device 130 or sent to the remote computing system 110. The exit data can include the exit time corresponding to a point in time at which the mobile device 130 entered the vehicle 210 and/or the beacon identifier.

At 540, computation, by the mobile device 130 or by the remote computing system 110, of transit data based on the entry data and the exit data. The transit data can include, for example, a route specified by the entry data and the exit data, time points during the route, user information, information about the vehicles 210 used, etc.

Additionally, fare data can contain information about the computed fare. The fare data can include, for example, amounts, receipt information, entry/exit points, usage statistics, suggestions for alternate routes/schedules, etc.

Also, transactions can be processed by remote computing system 110 or the mobile device 130 based on the computed fare. The fare data can include banking information relating to the user of the mobile device 130 and the fare provisioner. The mobile device 130 and/or the remote computing system 110 can facilitate the transfer payment of the fare from payment account associated with the user of the mobile device 130, to the fare provisioner, or to a third party.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a computing component (e.g., as a data server), or that includes a middleware component (e.g., an application server), or that includes a front-end component (e.g., a client computer having a graphical user interface or a Web browser through which a user may interact with an implementation of the subject matter described herein), or any combination of such computing, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method for automated fare processing comprising:
detecting, by a mobile device of a user, transmissions from a beacon located on a vehicle, the mobile device comprising a data processor, memory, and a wireless transceiver;
determining, by the mobile device and based on the detected transmissions, that the mobile device has entered the vehicle and storing associated entry data that comprises an entry time corresponding to a point in time at which the mobile device entered the vehicle;
determining, by the mobile device, that the mobile device has exited the vehicle and storing associated exit data that comprises an exit time corresponding to a point in time at which the mobile device exited the vehicle, at least one of the entry data and the exit data further comprising a beacon identifier; and
initiating computation of a fare incurred by the user based on the entry data and the exit data.

2. The method of claim 1, wherein the initiating comprises computing the fare and data associated with the fare on the mobile device.

3. The method of claim 2 further comprising:
transmitting, by the mobile device, the associated entry data and the associated exit data to a remote computing system;
wherein the remote computing system computes the fare and transmits data encapsulating the fare to the mobile device.

4. The method of claim 3 further comprising:
processing, by the remote computing system, the computed fare by deducting the computed fare from a payment account associated with a user of the mobile device.

5. The method of claim 1 wherein the determination of the entry data and the determination of the exit data comprise calculating, by the mobile device, the distance from the beacon to the mobile device, the calculated distance based on at least a signal strength of transmissions from the beacon at the mobile device.

6. The method of claim 1, wherein the entry data and the exit data further comprises geolocation data of the mobile device.

7. The method of claim 1, further comprising:
receiving, by the mobile device, of the beacon identifier and storing the beacon identifier along with a time stamp corresponding to the time the beacon identifier was received by the mobile device.

8. The method of claim 1, further comprising:
determining, by the mobile device, that the mobile device is within a barrier proximity that defines an area that extends a pre-defined distance from a barrier;
transmitting, by the mobile device to a server and based on the determination that the mobile device is within the barrier proximity, a request for the barrier to actuate; and
transmitting, by the server and based on the request, a command to an actuator controlling operation of the barrier to actuate the barrier.

9. The method of claim 1, further comprising:
determining, by the mobile device, that the mobile device is within a vehicle outer proximity that defines an area that extends into an area external to a physical extent of the vehicle;
transmitting, by the mobile device to a server, an outer proximity status of the mobile device, the outer proximity status including identification of the mobile device and an identification of the vehicle outer proximity that the mobile device is presently within; and
displaying, by the mobile device, information about the vehicle corresponding to the vehicle outer proximity that the mobile device is presently within.

10. The method of claim 1, further comprising:
transmitting, by the mobile device to a remote computing system, the entry data and the exit data for the mobile device; and
receiving, by the mobile device from the remote computing system, transit data representative of a transit environment, the transit data comprising occupancy data and scheduling data.

11. The method of claim 1, the entry data and the exit data both further comprising a beacon identifier, a location of the mobile device, a vehicle identifier, and a user identifier identifying a user of the mobile device.

12. The method of claim 1, wherein the entry data comprises a time at which the beacon transmission was first detected.

13. The method of claim 1, wherein the exit data comprises a time at which the beacon transmission was last detected.

14. The method of claim 1, wherein communication between the mobile device and the beacon is asynchronous.

15. The method of claim 1, wherein the entry data further comprises an entry location, the entry location identifying the location of the user at the entry time,
wherein the exit data further comprises an exit location, the exit location identifying the location of the user at the exit time, and
wherein the initiating further comprises:
calculating, by the mobile device, the fare based on the entry time, the entry location, the exit time, and the exit location according to a fare schedule stored on the mobile device.

16. A method comprising:
detecting, by a mobile device of a user, transmissions from a beacon located on a vehicle, the mobile device comprising a data processor, memory, and a wireless transceiver;
determining, by the mobile device and based on the detected transmissions, that the mobile device has entered the vehicle and storing associated entry data that comprises an entry time corresponding to a point in time at which the mobile device entered the vehicle;
determining, by the mobile device, that the mobile device has exited the vehicle and storing associated exit data that comprises an exit time corresponding to a point in time at which the mobile device exited the vehicle, at least one of the entry data and the exit data further comprising a beacon identifier; and
initiating, by the mobile device, of computation of transit data based on the entry data and the exit data, the transit data comprising a route specified by the entry data and the exit data.

17. A system comprising:
a beacon, a remote computing system, and a mobile device, the system configured to perform operations comprising:
detecting, by the mobile device of a user, transmissions from the beacon located on a vehicle, the mobile device comprising a data processor, memory, and a wireless transceiver;
determining, by the mobile device and based on the detected transmissions, that the mobile device has entered the vehicle and storing associated entry data that comprises an entry time corresponding to a point in time at which the mobile device entered the vehicle;
determining, by the mobile device, that the mobile device has exited the vehicle and storing associated exit data that comprises an exit time corresponding to a point in time at which the mobile device exited the vehicle, at least one of the entry data and the exit data further comprising a beacon identifier; and
initiating, by the mobile device, of computation of transit data based on the entry data and the exit data, the transit data comprising a route specified by the entry data and the exit data.

18. The system of claim 17, wherein the operations further comprise: initiating computation of a fare incurred by the user based on the entry data and the exit data on the mobile device, wherein the entry data and the exit data further comprises geolocation data of the mobile device.

19. The system of claim 17, wherein the entry data further comprises an entry location, the entry location identifying the location of the user at the entry time, a time at which the beacon transmission was first detected,
wherein the exit data further comprises an exit location, the exit location identifying the location of the user at the exit time, a time at which the beacon transmission was last detected,
wherein the entry data and the exit data both further comprising a beacon identifier, a location of the mobile device, a vehicle identifier, and a user identifier identifying a user of the mobile device, and
wherein the initiating further comprises:
calculating, by the mobile device, the fare based on the entry time, the entry location, the exit time, and the exit location according to a fare schedule stored on the mobile device.

20. The system of claim 17, wherein the operations further comprise:
determining, by the mobile device, that the mobile device is within a vehicle outer proximity that defines an area that extends into an area external to a physical extent of the vehicle;
transmitting, by the mobile device to a server, an outer proximity status of the mobile device, the outer proximity status including identification of the mobile device and an identification of the vehicle outer proximity that the mobile device is presently within;
receiving, by the mobile device from the remote computing system, transit data representative of a transit environment, the transit data comprising occupancy data and scheduling data; and
displaying, by the mobile device, information about the vehicle, including the transit data, corresponding to the vehicle outer proximity that the mobile device is presently within.
